(19) United States
(12) Patent Application Publication
(10) Pub. No.: US 2002/0162268 A1
(43) Pub. Date: Nov. 7, 2002

(54) Decoy with moveable, exchangeable parts

(76) Inventor: Daniel B. Fulcher, Spring Hill, TN (US)

Correspondence Address: Richard C. Litman, LITMAN LAW OFFICES, LTD., P.O. Box 15035, Arlington, VA, 22215, US

(21) Appl. No.: 09/845,292

(22) Filed: May 1, 2001

(51) Int. Cl. A01M 31/06

(52) U.S. Cl. 43/3

(57) ABSTRACT

An animated decoy which is constructed to simulate movement of an actual waterfowl/bird in its natural setting. The body of the decoy is fabricated from a plastic or hard foam material and is inserted in a cover made from PVC or similar material. The PVC cover is imprinted with an actual photograph of the body of the species of waterfowl/bird that the hunter or photographer intends to lure. The body of the decoy is provided with openings so that appendages of the decoy may be removably mounted on the body. These appendages are mounted for controlled animation and are coordinated with the photograph of the particular species to enhance the realistic effect.

### BACKGROUND OF THE INVENTION

1. Field of the Invention

The present invention generally relates to hunting accessories. More specifically, the present invention is drawn to an animated, radio-controlled waterfowl or game bird decoy.

2. Description of the Related Art

Usually, waterfowl and many game birds fly out of the normal range of the hunter's firearm or the wildlife photographer's close-up lens. Decoys are utilized to attract the waterfowl within range. It is a given that the more realistic the decoy, the more likely that the decoy will attract the intended subject. Immovable decoys have been used with less than satisfactory results, since an actual waterfowl/bird would typically move its head, wings and tail in a natural setting. Animated decoys have been employed with improved results. However, the prior art animated decoys still lack the realism necessary to “fool” the wary waterfowl/bird in consistent manner.

Examples of such prior art decoys are shown in U.S. Pat. Nos. 3,034,245 (Lynch) and 4,965,953 (McKinney) which depict remote controlled decoys. The remote control apparatus is mechanical, thus limiting the distance that the decoy may be displaced from the hunter.

U.S. Pat. No. 5,036,614 (Jackson) discloses an animated, decoy having a battery operated motor which allows the decoy to simulate only pivotal and oscillatory body movement. A range-limiting power cord switch arrangement is necessary to initiate and halt animation.

U.S. Pat. No. 4,845,873 (Hazlett) employs an electric motor housed in a decoy. The electric motor is manually operated by an on/off switch. The achieved animation of the wings and head is not realistic.

U.S. Pat. No. 6,170,188 B1 (Mathews) shows a decoy which utilizes a battery operated motor to provide animation to the wings of the decoy. The rotary movement of the wings does not simulate realistic motion produced by waterfowl.

U.S. Pat. Nos. 5,233,780 (Overholt), 5,289,654 (Denny et al.), 5,377,439 (Roos et al.), and 5,636,466 (Davis) disclose decoys whose animation is initiated via radio-controlled signals. The decoys of the instant patents are all limited in the variety of movements produced.

None of the above inventions and patents, taken either singularly or in combination, is seen to disclose an exact photocopy replica decoy having realistic movements and separable parts as will subsequently be described and claimed in the instant invention.

### SUMMARY OF THE INVENTION

The present invention comprises an animated decoy which is constructed to simulate movement of an actual waterfowl/bird in its natural setting. In the preferred embodiment, the body of the decoy is fabricated from a plastic or foam material and is inserted in a cover made from PVC or similar material. The PVC cover is imprinted with an actual photograph of the torso of the species and sex of waterfowl/bird that the hunter or photographer intends to lure. The hunter/photographer may therefore have several covers which are simulative of a variety of waterfowl/birds. It should be noted that the body may be directly painted to resemble the intended species or the body may have the photograph imprinted directly thereon.

The body of the decoy is provided with openings so that the head, tail and wings may be removably mounted thereon. These appendages are mounted for controlled animation and are coordinated with the photograph or painting of the particular species and sex to enhance the realistic effect. The appendages may also be provided with removable covers if desired and may be imprinted with a photograph or painted to resemble the species and sex of the intended waterfowl/bird.

Conventional motive means (motors and/or servo-mechanisms) are installed in the decoy body and connected to the appendages to effect sequential and realistic movement. As preferred, operation of the motive means is accomplished via a remote control signal. It is contemplated however, that the motive means can be timer operated if desired. The body is mounted on a support structure having a pivot head at one end. The other end of the support structure is adapted to be inserted in the ground.

Accordingly, it is a principal object of the invention to provide an animated decoy having means for effectuating natural body and appendage movement.

It is another object of the invention to provide an animated decoy having interchangeable appendages.

It is a further object of the invention to provide an animated decoy whose movement can be controlled via remotely transmitted radio signals.

Still another object of the invention is to provide an animated decoy which portrays an actual photographic image or painting of the hunted waterfowl/bird.

It is an object of the invention to provide improved elements and arrangements thereof for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a decoy with moveable, exchangeable parts according to the present invention.

FIG. 2 is an exploded, perspective view of a decoy with movable and exchangeable parts according to the present invention.

FIG. 3 is a top view of a decoy with movable and exchangeable parts according to the present invention.

Similar reference characters denote corresponding features consistently throughout the attached drawings.

### DETAILED DESCRIPTION OF THE PREFERRED EMBODIMENTS

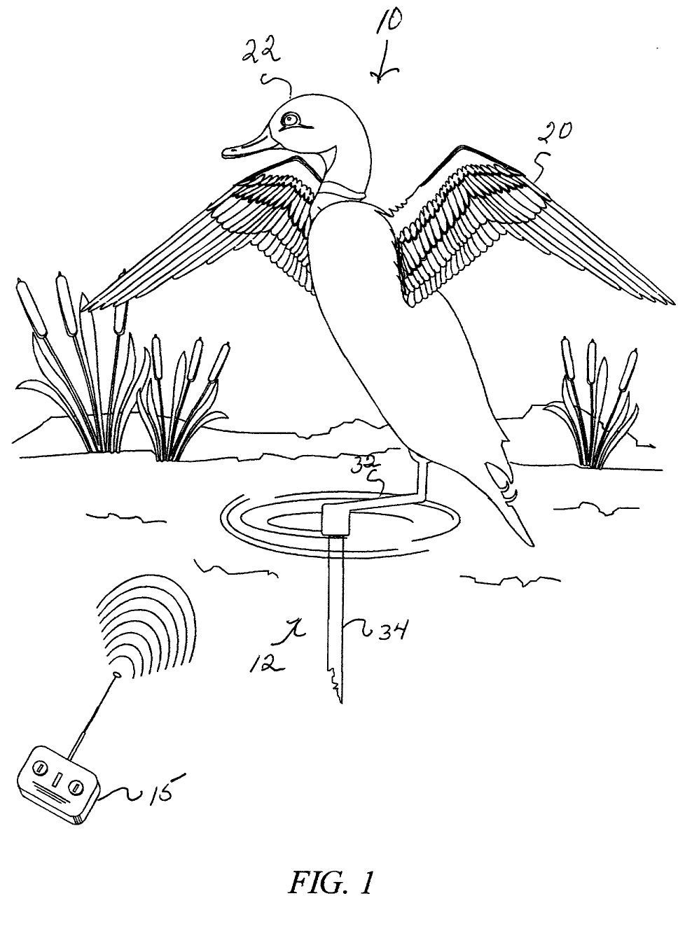

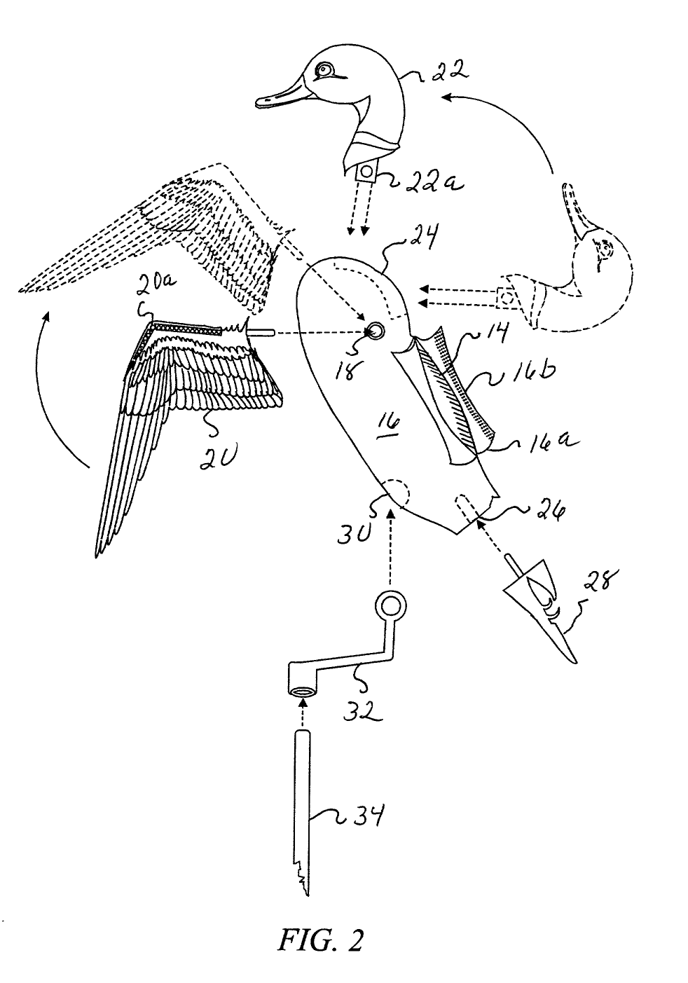

The decoy of the present invention is generally indicated at 10 in FIG. 1. Decoy 10 is mounted for pivoted movement on a support structure 12. As best illustrated in FIG. 2, decoy 10 comprises a body member 14 fabricated from easily assembled plastic or foam material. Body member 14 is removably inserted into an opening in cover a 16. After insertion the opening may be closed by flaps 16a, which flaps incorporate hook and loop fasteners 16b. Cover 16 is fabricated from PVC material or the like and has an exterior imprinted with an actual torso photograph or painting of a particular species of game bird or waterfowl.

Openings 18 (only one shown) are positioned in body member 14 and through cover 16 for removably receiving a set of wings 20. Wings 20 are fabricated from a plastic frame and are articulated at 20a. The wings are covered with a material similar to cover 16 and the covering is imprinted with an actual wing photograph of the species of game bird or waterfowl as depicted on the body cover. Wings 20 are mounted in openings 18 for controlled movement as further explained below.

Head 22 is fashioned to resemble the head of the respective chosen species of game bird or waterfowl and is painted in the requisite colors. A track mechanism 24 is formed in body member 14 and opens through cover 16 to receive mounting member 22a which is integral with head 22. Head 22 is removably mounted for movement on track 24.

A channel 26 (shown in phantom lines) is formed at the rear of body 14. Channel 26 is adapted to removably receive a replica of the tail 28 of the chosen species of game bird or waterfowl. As in the case of the wings, the exterior of the tail covering may be imprinted with a photograph of the tail of the chosen species. Tail 28 is mounted for back-and-forth horizontal movement in channel 26.

A semi-hemispherical opening 30 is disposed adjacent the rear of body 14. Opening 30 is adapted to receive pivot attachment 32. In turn, pivot attachment 32 is positioned atop support rod 34. The lower end of support rod 34 is adapted to be imbedded in the ground.

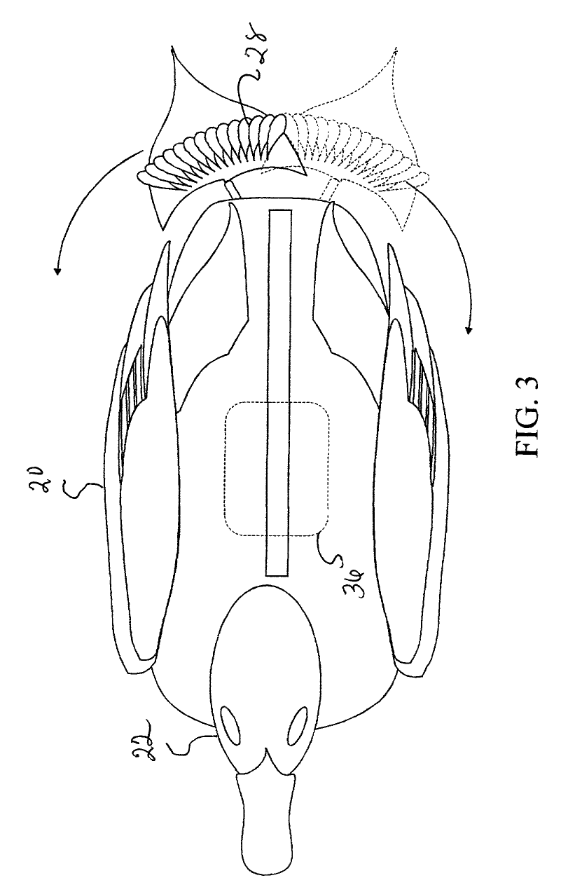

In use, the hunter/photographer selects the cover 16 and appendages 20, 22, 28 to match the characteristics of the species and sex of waterfowl/bird selected to be lured. The plastic (or foam) body 14 is inserted in the cover and the appendages attached thereto. The assembled waterfowl/bird is then mounted on pivot attachment 22 which is, in turn, mounted on support rod 34. The support rod 34 may now be inserted in the ground in a marsh area or similar venue frequented by the selected species. Conventional signal receiving and motive means 36 (shown in phantom lines in FIG. 3) is interconnected with the appendages and body to cause the appendages and body to move in a certain action sequence when the motive means receives a radio signal remotely transmitted by the hunter/photographer via a remote control unit 15 (FIG. 1).

As contemplated, the action sequence is as follows: (1) the waterfowl/bird pivots to an erect position as illustrated in FIG. 1; (2) while in the erect position the head rotates upwardly (FIG. 2) and the wings extend (FIG. 1) and flap back and forth a finite number of times; (3) the waterfowl/bird pivots to a sitting position with the head rotating downward and wings folded against the body (FIG. 3); (4) the tail moves back and forth a finite number of times (FIG. 3). This sequence will be repeated, when desired, simply by transmitting the remote signal.

It should be emphasized that the decoy of the instant invention is not limited to the illustrated species but may be fashioned to replicate almost any waterfowl or game bird (duck, goose, turkey, squab, etc.). It is also to be understood that the present invention is not limited to the embodiment described above, but encompasses any and all embodiments within the scope of the following claims.

I claim:

1. A decoy with moveable, exchangeable parts comprising:
an outer cover having an exterior surface;
a photograph of an actual torso of a game bird, said photograph imprinted on said exterior surface;
a cavity, said cavity defined by said outer cover;
an opening in said outer cover;
a body member, said body member being removably positioned in said cavity;
a pair of closure members, said pair of closure members disposed on said outer cover adjacent said opening, whereby said, closure members function to close said opening in said outer cover;
a plurality of simulated appendage members, each said plurality of simulated appendage members being removably attached to said body member;
first means for supporting said body member for pivotal movement thereon; and
second means disposed in said body member for causing animation of said body member and said plurality of appendage members in an action sequence.

2. The decoy as recited in claim 1, wherein said outer cover is fabricated from a rugged, pliable material.

3. The decoy as recited in claim 2, wherein said rugged, pliable material is PVC.

4. The decoy as recited in claim 3, wherein said body member is fabricated from a light-weight plastic material.

5. The decoy as recited in claim 4, further including;
hook and loop fastening devices, said hook and loop fastening devices being disposed on said pair of closure members.

6. The decoy as recited in claim 5, wherein said plurality of simulated appendage members is selected from the group consisting of a pair of simulated wings, a simulated head and a simulated tail.

7. The decoy as recited in claim 6, including a pair of articulated plastic frames, said pair of simulated wings being fabricated from said pair of articulated plastic frames;
a covering, said covering disposed over said plastic frames and defining exterior surfaces of said simulated wings;
a photograph of an actual pair of wings of a game bird, said photograph imprinted on said exterior surfaces of said covering.

8. The decoy as recited in claim 7, including a remote device selectively transmitting a radio signal, said second means for causing animation being actuated by said radio signal.

9. A decoy with moveable, exchangeable parts comprising:
a body member having an exterior surface, said exterior surface of said body member being painted to replicate an actual torso of a game bird;
a plurality of simulated appendage members, each said plurality of simulated appendage members having exterior surfaces and being removably attached to said body member;
first means for supporting said body member for pivotal movement thereon; and
second means disposed in said body member for causing animation of said body member and said plurality of appendage members in an action sequence.

10. The decoy as recited in claim 9, wherein said exterior surfaces of said appendage members are painted to replicate appendage members an actual respective appendage member of a game bird.

11. The decoy as recited in claim 10, wherein said plurality of simulated appendage members is selected from the group consisting of a pair of simulated wings, a simulated head and a simulated tail.

12. The decoy as recited in claim 11, including a remote device selectively transmitting a radio signal, said second means for causing animation being actuated by said radio signal.

13. A method of operating a game bird decoy, which decoy comprises,
a body member;
a plurality of simulated, movable appendage members , each said plurality of simulated, movable appendage members attached to said body member, said simulated, movable appendage members selected from the group consisting of a pair of wings, a head and a tail;
first means for supporting said body member for pivotal movement; and
second means disposed in said body member for causing animation of said body member and said plurality of appendage members in an action sequence, said method comprising the steps of:
causing said decoy to pivot from a sitting position to an erect position while causing said head to move in an arcuate plane;
causing said pair of wings to extend and flap;
causing said decoy to pivot from said erect position to said sitting position; and
causing said tail to move back and forth in a horizontal plane.

14. The method as recited in claim 13, wherein said pair of wings are caused to flap a finite number of times.

15. The method as recited in claim 14, wherein said tail is caused to move back and forth a finite number of times.
